(19) United States
(12) Patent Application Publication
(10) Pub. No.: US 2005/0289042 A1
(43) Pub. Date: Dec. 29, 2005

(54) Auction merger system

(76) Inventor: Richard W. Friesen, Fairfax, CA (US)

Correspondence Address: Thomas N. Giaccherini, Post Office Box 1146, Carmel Valley, CA, 93924, US

(21) Appl. No.: 10/877,236

(22) Filed: Jun. 24, 2004

(51) Int. Cl. G06F 17/60

(52) U.S. Cl. 705/37

(57) ABSTRACT

Methods and apparatus for creating and displaying a market for auctions. Many users who are connected by a network may participate in a number of different types of simultaneous auctions using a computer or some other terminal or other appliance.

### FEDERALLY SPONSORED RESEARCH OR DEVELOPMENT

None.

### FIELD OF THE INVENTION

The present invention pertains to methods and apparatus for creating and displaying a market for auctions. More particularly, many users who are connected by a network may participate in a number of different types of simultaneous auctions using a computer or some other terminal or other appliance.

### BACKGROUND OF THE INVENTION

While auctions have been conducted for hundreds of years, on-line auctions that are available to the public are barely a decade old. The most famous of on-line auctions is conducted by eBay, a company which was founded in California in September of 1995. This company has created what they call The World's Online Marketplace™ for the sale of goods and services by a diverse community of individuals and businesses. The eBay community includes tens of millions of registered members from around the world. On an average day, there are millions of items listed on eBay. Anyone with a computer, an Internet browser and a connection to the Internet can access eBay. The eBay website contains an index of all the items that are currently being auctioned. A user may select one of the many classifications, such as “cars, “toys” or “antiques.” All the items within these categories are then displayed to the user on his or her computer monitor. Each item is the subject of its own single auction. Potential buyers can view information about an item being auctioned, and may place a bid. The seller may impose a minimum bid requirement called a “reserve.” Each auction has a specified time limit which defines the time when no further bids will be accepted. When this predefined time arrives, the highest bid wins, unless it falls below the reserve price. In general, this type of auction, which rewards the highest bidder after a succession of bids, is called an “English Auction.” An English Auction is only one “type” or “kind” of auction. In another type of auction, called a “Dutch Auction” or an initial price is set by the seller. The price is then lowered incrementally, and the first bidder wins.

The current selections of on-line auctions which are available to the public in unregulated markets are generally limited to English Auctions, in which a single auction is conducted at any given time for a single item. In these auctions, the seller and bidders must generally adhere to rules set by the auctioneer. Internet access to the regulated markets is generally limited to Continuous Double Auctions. In these auctions, the sellers place offers and the buyers place bids and must adhere to the rules of regulated exchange.

Several papers have been published which describe a more complicated type of auction, called a “multiple auction,” in which several auctions are conducted in a series for the same item. In a paper entitled A New Bankruptcy Procedure That Uses Multiple Auctions, Hart et al. describe a method creating a linear series of three auctions for a firm that has been placed in bankruptcy. National Bureau of Economic Research, November, 1997. In their paper entitled Economic Dynamics of Agents in Multiple Auctions, Preist discloses an agent that is able to participate in multiple auctions that may occur on different exchanges for a given good. HP Laboratories Bristol, 9 May 2001. In a document entitled Evolving Bidding Strategies for Multiple Auctions, Anthony et al. describe a heuristic decision-making framework that an autonomous agent can exploit to tackle the problem of bidding across multiple auctions on different exchanges. Department of Electronics and Computer Science, University of Southampton.

None of the conventional on-line auction systems nor the academic work that are presently on the market and that are available to the public extend beyond single auctions with rules determined by the exchange or auctioneer. The development of a more flexible system which is capable of being defined by auction participants would constitute a major technological advance, and would satisfy long felt needs and aspirations in the on-line auction and trading industries.

### SUMMARY OF THE INVENTION

The present invention comprises methods for integrating different types of simultaneous auctions. Users may view these auctions on the display of a computer, or some other suitable terminal, which is connected to a network. The invention enables users to participate in multiple simultaneous auctions of different type. The market created by the present invention allows and a user to determine not only the price and quantity of an order, but also the type of auction the order may participate in, or create an auction that the order may participate in. The exchange coordinates all trading activity from all auction types so that eligible orders may be executed by a rule based system in the various auction types. Additionally, a user may view the auction process of multiple auctions on a Graphical User Interface (GUI) designed to display this information. The present invention also provides a method for a user to enter an order. Users may also be ranked by their success in the auctions they create. This present invention also allows use of auction types to be determined by the market place and changed by user initiative according to market conditions without exchange rule changes.

An appreciation of the other aims and objectives of the present invention, and a more complete and comprehensive understanding of this invention, may be obtained by studying the following description of a preferred embodiment, and by referring to the accompanying drawings.

### A BRIEF DESCRIPTION OF THE DRAWINGS

FIGS. 1, 2 and 3 depict a conventional online unregulated auction market.

FIG. 4 illustrates the present invention which shows a single market for a single good that may contain multiple auctions and auction types, in this case 1 Gram Gold Bars.

FIG. 5 illustrates a table view of multiple auctions of the same item shown on the same price scale

FIG. 6 illustrates how orders from different sources, entered into differing auction types are sent to a server for integration and execution

FIG. 7 illustrates how the Priority Grid takes various orders from various auctions and integrates their executions with a rule based system

FIG. 8 illustrates one cell of the Priority Grid and illustrates a single rule for matching orders in a CDA and Dutch Auction.

FIG. 9 exhibits a method of giving the user the ability to choose an auction type for each order sent to an exchange.

FIG. 10 provides a view of a method of giving the user the ability to enter an order in multiple types of auctions while at the same time giving the user only the fields necessary to fill in as the information entered determines the necessary remaining fields that need to be completed.

FIG. 11 offers an example of typical price chart for any commodity, futures, options or stock.

FIG. 12 supplies a view of a method of showing historic data for multiple auctions on the same screen that are all linked to the same exchange

FIG. 13 supplies a view of a method of showing historic data for single auctions on the same screen that are all linked to the Dutch Auction.

FIGS. 14 and 15 depicts a method of using different symbols for different auction types.

FIG. 16 illustrates a graphical method of displaying historic activity in multiple auctions for any market, including, but not limited to, a futures, options or stock market.

FIG. 17 shows an arrangement of the display of prices of multiple items, in this case different expiration months by the most popular futures price and screen vendors who get prices from an exchange and display them in more usable fashion for the user

FIG. 18 illustrates a common method of displaying bids and offers in a regulated market in a single item

FIG. 19 illustrates a notification screen of the present invention that allows the user to set notifications filtered by auction type, volume, user or other filters.

### A DETAILED DESCRIPTION OF PREFERRED & ALTERNATIVE EMBODIMENTS

I. Overview of the Invention.

The present invention comprises methods and apparatus for creating a market for auctions. In one embodiment, the invention provides an improved on-line auction that resembles eBay®, but offers enhanced flexibility for users. In accordance with this implementation of the invention, the users can determine which types of existing auctions in which their order will participate, initiate a new auction from a list of approved auction types, define their own auctions by initiating those auctions in accordance with the rules that they choose, and by selecting the types of auctions in which they wish their orders to participate. The invention may be implemented using an exchange. In one embodiment of the invention, this market integrates or “merges” different types of simultaneous auctions in a single, easy-to-use graphical interface. Users may view these auctions on the display of a computer, or some other suitable terminal, which is connected to a network. The invention enables users to participate in multiple auctions of different type. The market created by the present invention allows the a user to determine not only the price and quantity of an order, but also the type of auction that may be conducted.

In this Specification and in the claims that follow, the terms recited below are associated with the following basic definitions:
Auction: Any transaction involving an item, a user who receives or views data concerning a transaction, a potential seller and/or a potential bidder. An auction may include no bids, one bid, or a number of bids.
Auction Host: An auction host is a person, company or entity that enables an on-line auction. In general, an auction host controls the computer or server and software that presents the auction market to users.
Item: Any good, service or intangible which may be conveyed in an auction.
Market: A nexus of auctions, data, items and users, including potential sellers and buyers.
Network: One or more connections for enabling communications between or among users.
User: A person, company, firm, entity or agent which may receive or view data, or which may participate in an auction.
   II. Conventional On-Line Auctions

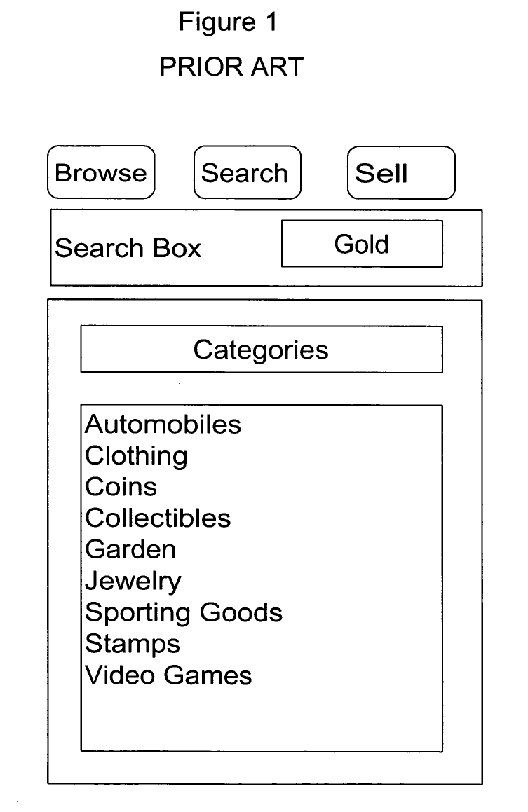

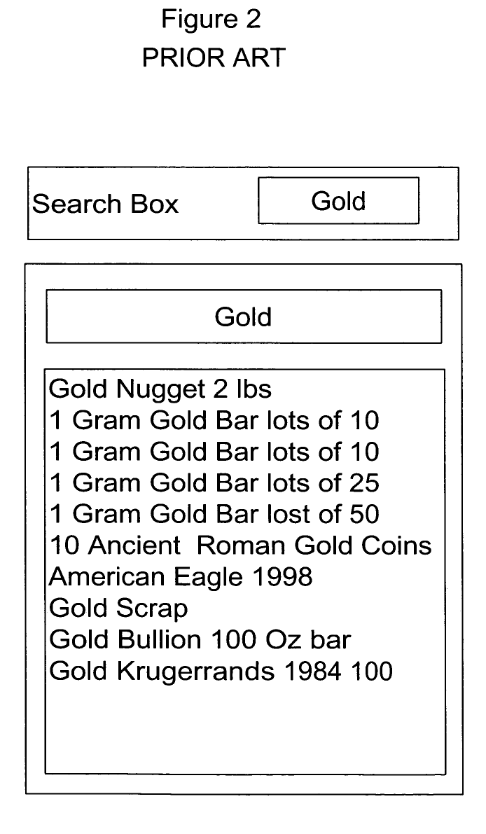

FIG. 1 offers a view of a home page of a website that offers a conventional on-line auction. This drawing depicts a generalized page from a website like eBay® which may be accessed by a member of the public using a computer and an Internet browser, such as Microsoft® Internet Explorer. This page enables a user to browse or search for a particular item which is being auctioned. As an example, a user may enter the term “gold” in the search field. A set of items that fall within that category are displayed on a new page, as shown in FIG. 2.

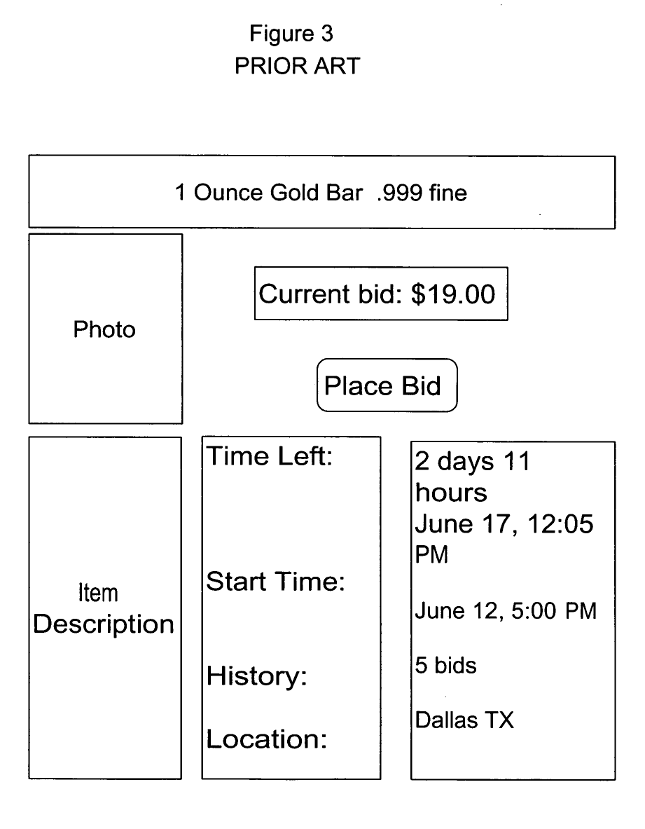

Each item presented in the list on the page shown in 2 is a “clickable” link, meaning that the user may move his or her cursor over the link, and then select it with the click of the mouse. When an item is selected in this way, another third new page opens that shows items in that category as shown in FIG. 3. The third page provides a variety of information about the item, and its auction, potentially including:
A description of the item
A photograph of the item
The start time of the auction
The end time of the auction
The starting bid
The bidding history
The location of the item
Shipping information
Payment terms and information
Seller information, including seller history and reputation in the auction market

A user may place a bid in a field provided on the screen. In general, users must first register by sending information to the auction host. Registration provides the user with a user name and a password for accessing his or her account.

In general, all the rules of a conventional on-line auction are predetermined by the auction host. One user may place one bid per item. This bid is placed in a single auction, and for a single item. Other preset rules govern this single auction. As an example, all ebay® users must abide by the following general rules for bids:
“How to Bid
   Once you find an item you're interested in, it's easy to place a bid. Here's how:
1. Once you're a registered eBay member, carefully look over the item listing. Be sure you really want to buy this item before you place a bid.
2. Enter your maximum bid in the box at the bottom of the page and then click the Review Bid button.
3. Enter your User ID and password and then click the Place Bid button. That's it! eBay will now bid on your behalf up to the maximum amount you're willing to pay for that item.
You'll get an email confirming your bid. At the end of the listing, you'll receive another email indicating whether you've purchased the item with an explanation of next steps.”
   III. A Detailed Description of a Preferred Embodiment of the Invention

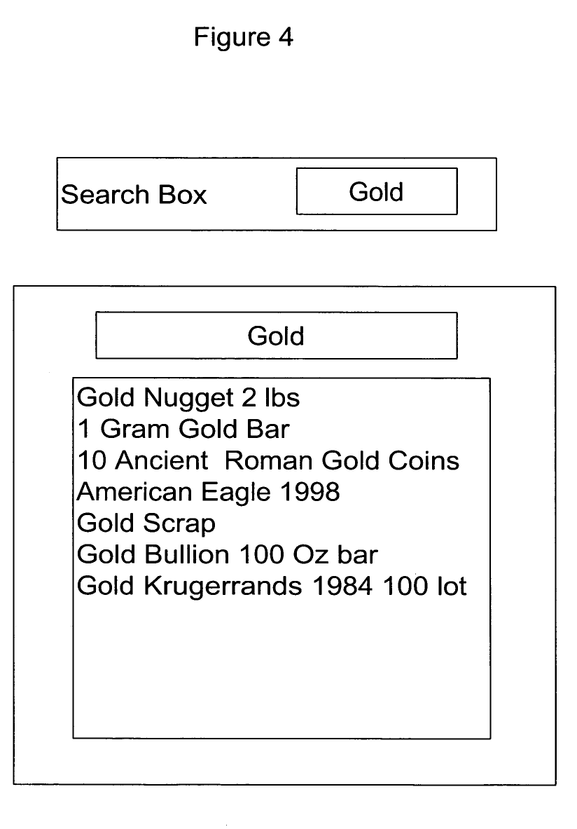

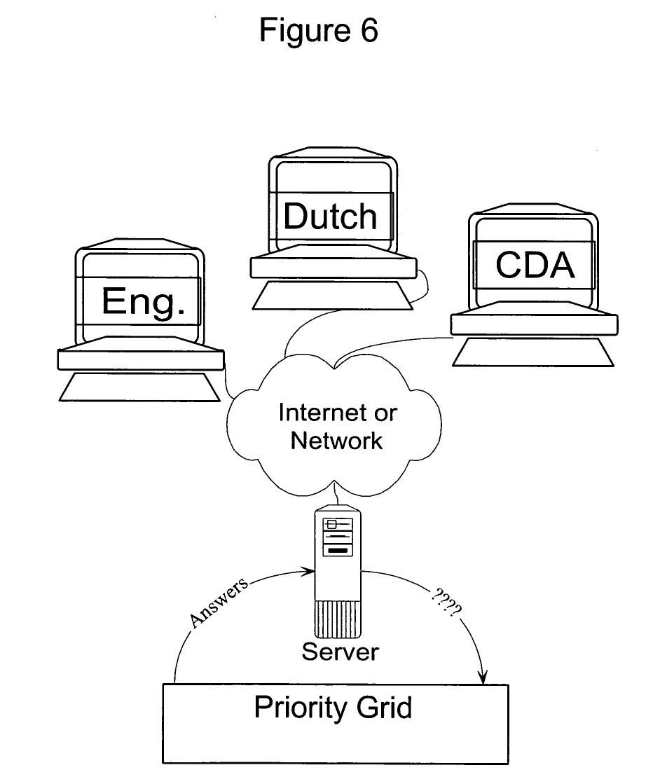

FIGS. 4 through 10, 12 through 15 and FIG. 18 depict web pages that illustrate the auction market in accordance with the present invention. Unlike conventional on-line auctions, the present invention empowers a user to define the auction market. A user accomplishes this freedom of transaction by proposing rules for his or her own auctions, initiating auctions and by selecting the auctions in which he or she will participate. The user may also participate in multiple simultaneous auctions of different type.

In this particular embodiment of the invention, the current online auction permits its users to either buy or sell an item by starting an auction, or to buy or sell an item by bidding or offering on an item that is already for purchase or sale in an auction. In current on-line auctions, if two users want to sell 100 of the same item each, each user initiates an independent auction. Thus a buyer would have to bid in one or both of the auctions and the price of the transactions could vary between the two auctions. However, this embodiment of the present invention combines all auctions for fungible item into a single market, and then allows multiple auctions within that market.

Rather than having multiple unrelated auctions at the same time, there would be one market for “1 gram gold bars” with multiple types of auctions in that market. The important difference is that a bid or offer in one auction could be executed against a bid or offer in another auction or other type of auction as permitted by the Priority Grid. This interaction would result in uniform pricing at any given time and a smooth transition of prices with the passage of time.

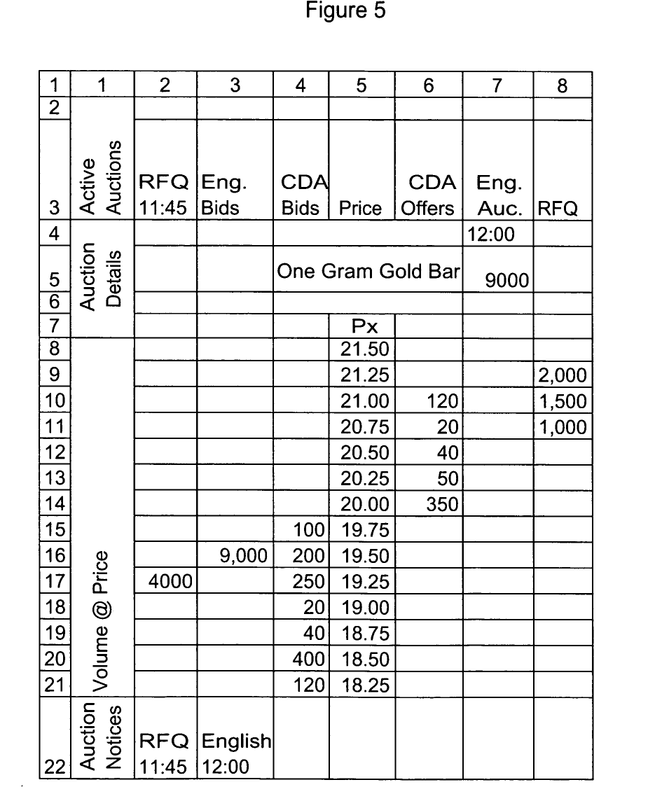

FIG. 4 provides a view of a sample screen that may be generated using the present invention. If a user enters the term “gold” in the Search Field, a list of related auction items is displayed below the Search Field, as shown in FIG. 4. When item labeled “1 Gram Gold Bar” is clicked on in FIG. 4, the market site which is represented in FIG. 5 is displayed.

FIG. 5 shows a market place created by the present invention. Unlike conventional on-line auctions like eBay, which list several entries for the same item, each initiated by a different seller, FIG. 5 shows an integrated market place with not only English Auctions, as are typical on the internet auction sites, but also includes a Request for Quote (RFQ) and a Continuous Double Auction (CDA). On high resolution monitors, this screen could show many additional simultaneous auctions at the same time. These three auctions shown here are examples. All these auctions with their orders are represented on the same price scale.

FIG. 5 shows a user screen for the “1 Gram Gold Bar.” The item could represent any tradable item. The column and row numbers on the top and the left side of the diagram are reference numbers for this description, and would not normally be included in the screen interface. The unifying factor of this representation of multiple coordinated auctions is the price scale located in column 5 starting with row 8. The information in this location indicates the price, starting at the highest active price, moving down the scale to the lowest active price. In this implementation, all the types of coordinated auctions are matched to this single price scale. In the preferred implementation, all the bids are to the left of the price scale, and all the offers are to the right of the price scale.

For example, in column 4, the CDA (continuous double auction) bids are listed. In column 6, the CDA offers are listed. Each of the cells in the bid and offer columns, list the volume of the bids or offers available for immediate execution at the adjacent price scale in column 5. This arrangement is typical in many trading screens available for stocks and futures.

FIG. 5 also exhibits additional types of auctions. In this implementation, each auction is split with its bids on the left of the price scale, and the offer on the right of the price scale. Other implementations could place the bids and offers for each auction together. The advantage of this arrangement is that a user can easily see all the bids from all auction types in one area, and all the offers from all auction types in another area, making it easier to make a judgment about relative buying and selling pressures.

In Row 2, a single buyer presents a Request for Quote (RFQ). He has stated a bid volume of 4,000 items with a firm price of $19.25 and is looking for offers. Under column 8, the RFQ offers are listed and we see three offers ranging from 20.75 to 21.25 with an accumulated volume of 4,500 units.

In Row 7, a typical English Auction is initiated with the offer of 9,000 units. Since the price of the 9.000 has not been determined, they are mentioned in the heading only. If they had a minimum price, the volume would be listed at the minimum. The responses to the English Auction are listed in row 3. We can see there is one bid, with 9.000 units bid for.

Row number 3 is a heading which identifies the type of auction. A click on any auction type will bring the user to a new screen which gives the details of that particular auction and the ability to enter an order in that particular auction. Row 4-7 are available to list any necessary overview of the auction. A mouse click on any of these cells will bring up the auction detail screen.

Rows 8-21 furnish the volume and price of active orders. The bids are on the left side of the price column with the volume of the bid stated in the cell on the same level as the price at which that amount of volume is bid for. The offers are on the right side of the price column giving the volume of the order corresponding to price at the same level.

Row 22 gives a list of auction notices that have gone out to subscribers of such notices. A click on these cells will bring up a screen that gives the details of such auction notices.

IV. An Alternative Embodiment—Securities & Options Trading

An alternative embodiment of the invention provides for auctions of securities, options or other instruments. This embodiment of the invention may be based in an exchange, such as the Chicago Mercantile Exchange or the New York Stock Exchange. In general, an exchange is a single entity or governing body that has a set of rules that govern access and membership, the type of items to be traded, the trading rules and types of auctions permitted and acts as the auction host. It may be sanctioned or regulated by a Federal Agency. Unlike an on-line auction which is available to the general public, a financial exchange usually limits trading access to recognized members, brokers and their users.

In this embodiment, a user may place an order with a price and quantity, and may also select an auction type that best suites that particular order for the existing current market environment. Many items that trade on regulated stock, futures and options exchanges suffer from the problem of a volatility of volume over time, meaning that a single item can be very active and highly liquid at certain times and inactive at other times. During the active times, there are a large number of bids and offers, and the price differential between the highest bid and the lowest offer can be very close. At other times, their may be less interest in the item or contract, with few bids and offers and a larger price differential between the highest bid and the lowest offer. Each of these different conditions creates a need for a different type of auction. For example, when the item is very active, a CDA market is appropriate. Large orders can be handled quickly and efficiently. Protracted auctions such as the Dutch or English Auction may not be appropriate. As the volume slows, the item may still has a large open interest, (many outstanding items that are owned). However, the lower volumes make it difficult for the occasional buyer or seller to attract a sufficient bids or offers in a CDA market. At these times, a Negotiated, English or Dutch auction may be more appropriate.

Options are an excellent example of an item that has a high volatility of volume over time. When an option is “at the money,” it trades at its most liquid. When an option goes “out of the money” or deep “in the money,” its liquidity and volume are generally diminished. However, many users will still have positions in those options which were established on when the options were closer to “in the money.” This method of allowing the user to determine the type of auction for the order would allow the user to adjust the order and auction type to suit the current market conditions. This same principle also applies to the futures markets, where the near term future (the contract or item that is closest to expiring) will be the most liquid. The contracts that are dated for later delivery become less active, and would be better served with multiple auctions types. This same principle applies to stocks that are very liquid at some point in time and less liquid during other stages or cycles. The active stocks would be primarily served by the CDA and when the stocks were less active, and they could be served by other preferred auction types.

This relationship allows all orders of any auction type to interact, while, at the same time, protects all orders of any order and auction types to be executed under their own rules, and yet also to participate in the rules of other auction types. Without this invention in today's market place, an item will trade with one auction type, running on a single exchange. For example, the Chicago Board of Trade will trade Wheat Futures in a CDA, or Continuous Double Auction and the user has no choice as to they type of auction for the order unless they leave the exchange to trade directly with another user.

In an existing futures or stock exchange using a Continuous Double Auction, if there is an offer to sell at $3.25, there can't exist an order to buy and pay $3.50 without an execution. Otherwise an execution would “trade-through” an existing bid or offer. A “trade-through” is an execution of two orders at a price higher than an existing offer or lower than an existing bid. The floor members will constantly bid and offer, so the entire floor is aware of all the orders that can possibly be executed. However, away from the trading floor, it is possible for a farmer and a grain elevator operator to negotiate a wheat trade in Wichita Kansas, without any other users in other private negotiated markets or the exchange markets to be aware of this or other negotiated trades. Thus, none of these non-exchange orders, have the ability for their order in one auction form (negotiated in this example) to be executed in the other auction (CDA auction on the floor of the exchange in this example).

All orders of all auction types, as they meet in this invention's market, are protected from “trade-through.” All permissioned orders, even orders of differing auction types, are available for execution in the multiple auctions. The present invention brings in multiple types of auctions to one exchange. Accordingly, one feature offered by the invention is that the orders from one auction type be able to be executed with orders from another auction type. Otherwise, if the orders from the different auction types are not be executed against each other, the auctions will degenerate into separate markets. One advantage of the present invention is that the negotiated order, and the orders in the CDA market, will be able to transact with each other.

The initiator of an order has several levels of choices to make regarding how that order may be executed. First, an initiator may permission the order to participate in additional auction types by checking a permission box for each type of existing auctions in which the orders may participate. Secondly, if an initiator believes that the existing active auctions are not the best alternative for the order; a user may initiate a new auction to accommodate the order. Finally, if the existing auction types defined by the exchange are not sufficient for the auction initiator, the auction initiator may custom design an auction type either from templates provided by the exchange or through a free form announcement to the like minded users.

To discourage frivolous auctions and quote requests, a user who initiates an auction or a quote may be subjected to a peer rating system. For example, in the RFQ market, the data about an order or an auction initiator may be displayed on the graphical user interface. This data may include the order or auction initiator's record of the ratio of quote requests to order execution. In this way, all users remain anonymous, but their trade history may be published along with their auction or quote activity.

An auction or order in auction A that does not conform to the rules of another particular auction, auction B, can still be displayed in auction B, however it can be displayed in a way that indicates that that particular order or auction from auction A is not actionable for auction B. As an example, an order auction A may be grayed out, or may be presented in a different color or font compared to other actionable auctions presented on the screen. A user may click on that unactionable order from auction A to go to the auction where an order could be placed that is actionable with the order or auction A.

Execution priority is determined by the rules of the exchange as listed in the Priority Grid. These rules govern the integration of different types of orders for multiple auctions running at the same time. This execution priority may be adjusted in real time. Order execution priority between simultaneous auction types may be determined by a hierarchy of execution priorities. These execution priorities may be set by the exchange, and may be published.

V. The Priority Grid

If users enter orders at various prices in different types of auctions, and these orders are not executable against all the other orders of a similar item, a series of isolated markets is created, and concentration of interest in the item is diminished with distribution to multiple unconnected auctions. This has the effect of lowering the liquidity for the item. If the orders in all auction types are able to be executed against all other orders in a single market place, this has the effect of concentrating the liquidity. Then, no matter what type of auction that an order is placed, it is not isolated in that auction, but could be executed against an order place in an entirely different auction. This solution however, creates a problem for the auction host. Each type of auction has rules that state how orders within a single auction type are executed against each other. By allowing orders in multiple types of auctions to be executed against each other, a new set of rules is needed to determine how orders in one auction type are allowed to interact against orders in another auction type. Since the number of auction types allowed could be two or more, with the potential of ten or more auctions types, plus the addition of custom auctions created by users, one embodiment of the invention provides a way to resolve the issue of how an order in one auction type relates to an order in all other auction types. This results in the number of inter-auction rules according to the following formula where X equals the number of auctions and Y equals the number of total rules, as given in Equation One:
X²=Y Equation One.
If an exchange were to permit 10 auction types, then the number of potential interactions would be 10²=100, if we included orders in the same type of auction interacting with each other. The present invention furnishes an interaction process that is labeled the “Priority Grid.” The Priority Grid gives the rules for the orders in each auction interaction. The orders are broken into two categories, initiating and responding. Each of these orders in each auction is given an absolute priority number, in this case, a number from 1-100. An order with a priority number of “100” will get first priority over any other orders in the same group. An order with a priority of “1” will be the last to be executed against orders of the group. However, because differing auction types follow very different rules, more than just a priority number is required, but a set of rules that states which order is executed at a specific time.

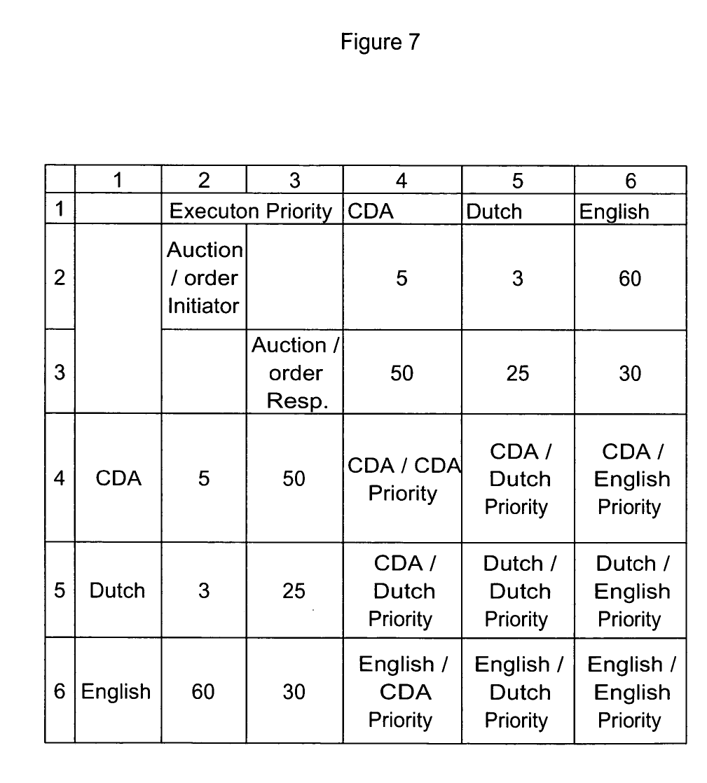

FIG. 7 shows a Priority Grid with only three auctions as an example. Column 1 includes a list of three auctions: CDA, Dutch and English. Row two includes the same list of auction types. Row 2-3 provide the execution priority numbers for an order in that auction, separated by whether or not that order is either an initiating order or a responding order. Columns 2 and 3 represent the execution priority numbers of the corresponding auctions in column 1. Column 4-6, in row 4-6 depict the set of rules which specify what happens to orders that have the potential for execution from the corresponding auction types.

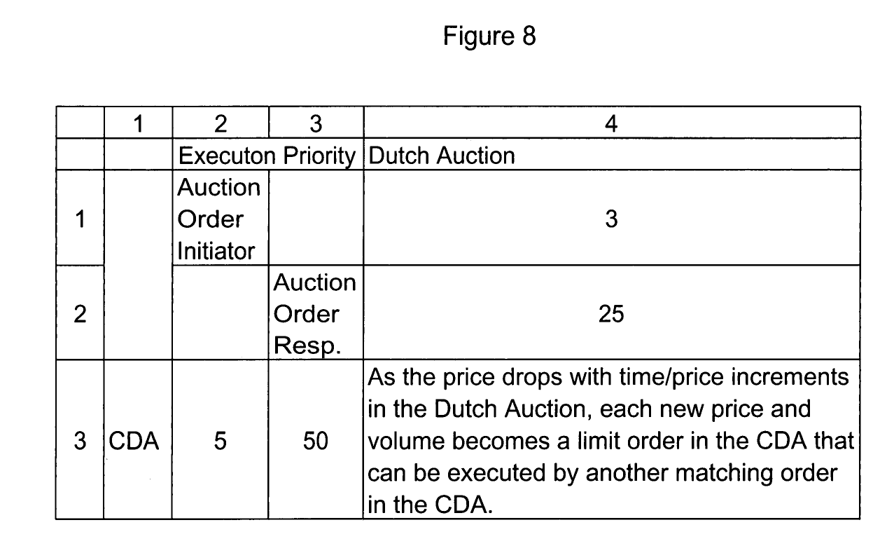

FIG. 8 illustrates a single cell with instructions on how to handle orders that are executable between the CDA Auction and a Dutch Auction. In this example, an order initiated in a Dutch Auction (in this case the order creates the auction itself) has a 3 priority (Row 1, Column 4) for the same price of a responding order in the CDA market. The text box (Row 3, Column 4) gives the rules as a formula or descriptive text for executing both orders across the two auctions. Multiple layers of rules can be created for each auction interaction. If executed by a computer, these rules will need to be translated to computer code.

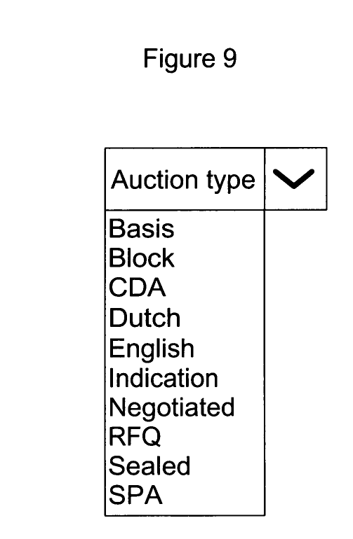

FIG. 9 illustrates a method of giving the user the ability to choose an auction type for each order sent to an exchange. A “drop down” or “type in” menu allows the user to fill in the auction type. Once the auction type is selected, then the cells appear that are tailored for that particular auction. This reduces what would otherwise become a huge array of order entry parameters.

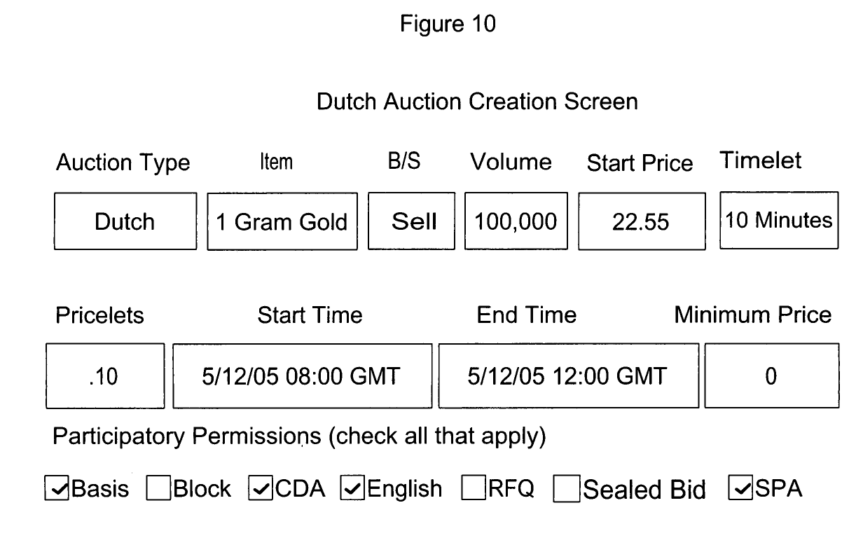

FIG. 10 exhibits a method of giving the user the ability to enter an order in multiple types of auctions, while at the same time giving the user only the fields that require information. The information that is entered determines the necessary remaining fields that need to be completed. Once a type of auction is selected, only the required cells are displayed. If a Dutch Auction is selected, then the cells that appear are only those needed for just the Dutch auction. As additional information is entered into these cells, more selection cells will appear that require more selections based on the continued selections of the user.

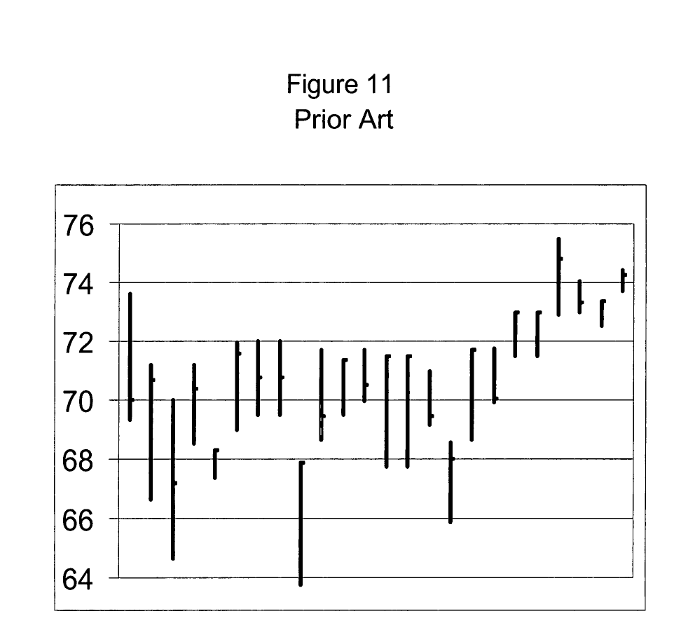

FIG. 11 offers an example of typical price chart for any commodity, futures, options or stock. On the left side, FIG. 11 lists the price increments on the Y Axis, normally the highest price at the top, and the lowest price at the bottom. The X Axis is the time axis, and could range from a one minute per bar to 1 month per bar. The high point of each bar is the highest executed price during that time period, and the lowest point of each bar is the lowest price executed during that time period. The hash mark to the right of each bar is the last price executed during that time period.

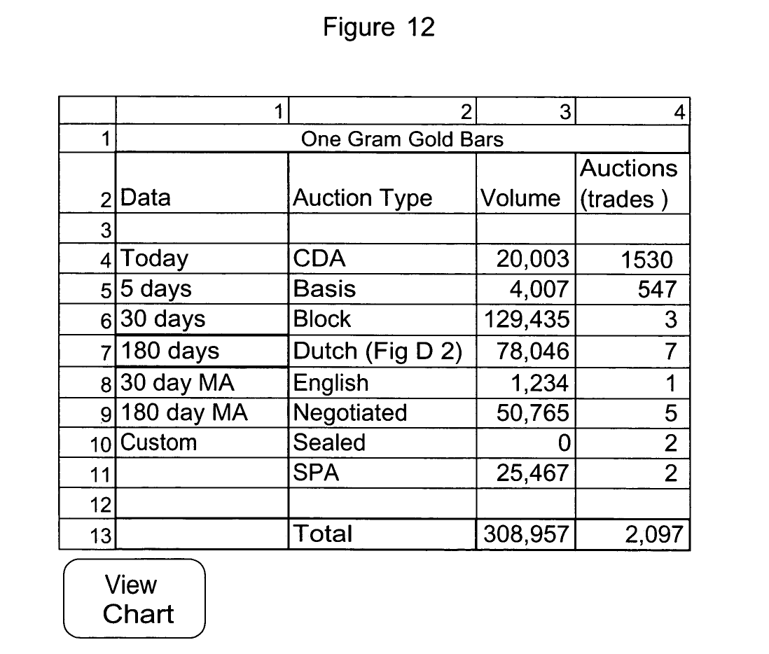

FIG. 12 furnishes a view of a method of showing historical auction activity from multiple auctions on the same screen that are all linked to the same market. The graphical user interface is designed to disseminate and to integrate, for each auction type, the information for each market. The interface is designed to create user satisfaction and to produce liquidity. A single screen is able to give the user the information from all auction types either in a single price grid, or side by side. Selection of the order or auction with a computer mouse or other selection devise will open up a screen with more resolution and information that auction, order entry capability with a screen format that best suits that auction type. Column 3 and 4 represent the individual auctions and total volume for that period of time. Column 2 lists the types of auctions that are available for that item. Column 3 shows the volume and Column 4 shows the number of auctions. The user can click on any cell to bring up an additional screen with more detailed information. For example, clicking on the CDA Auction would bring up a screen that showed a list of CDA Auctions. Each Auction could be selected and clicked to bring up the details on that particular auction type. The user can also select a graphic history of the volume by clicking the Chart button at the bottom of the screen.

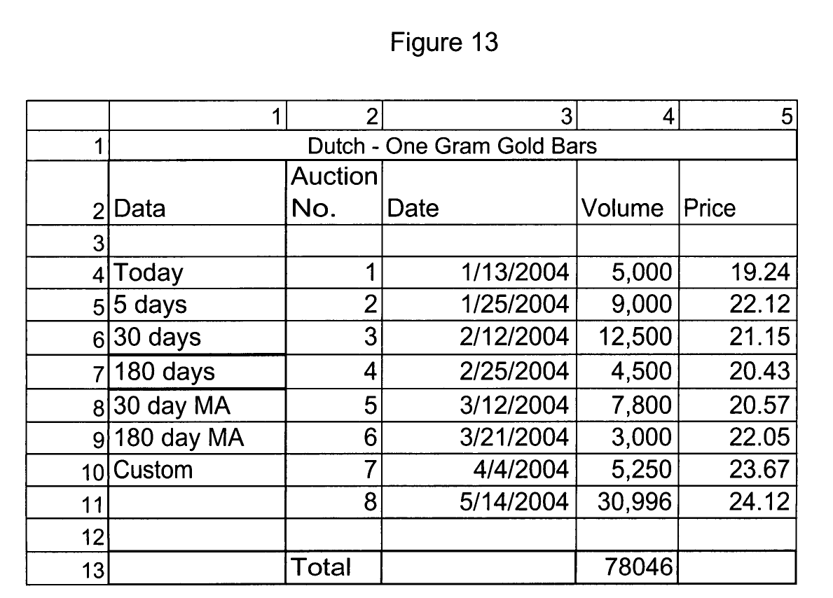

FIG. 13 shows a single auction history, in this example, the Dutch Auction. This screen appears after clicking on the Dutch Auction in FIG. 12. Column 1 gives the user a choice on the time period to display the auction history. Column 2 gives the auction number. Column 3 gives the date of the auction. Column 4 gives the volume executed at that auction, and column 5 gives the price of execution.

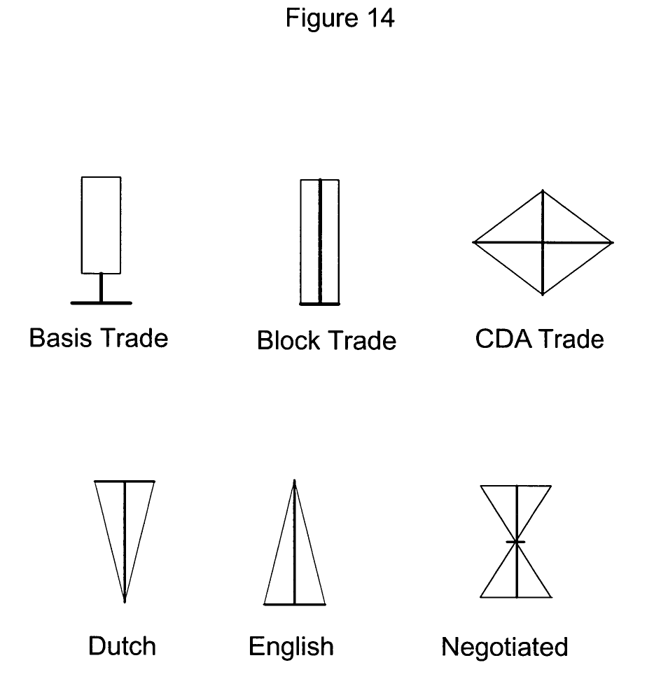

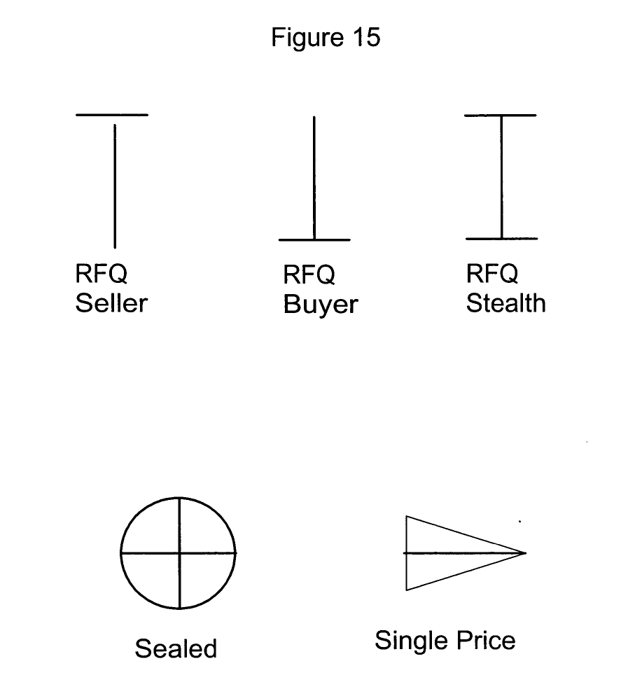

As shown in FIGS. 14 and 15, the present invention furnishes a method of using different symbols for different auction types; a method of placing these symbols on a single screen; a method of placing of these symbols that represents price and time along each axis; and a method of matching the size of the symbols to the volume of the order. In general, the placement of the symbol represents price and the width of the symbol represents the volume transacted in that auction. In one embodiment, if a symbol is a does not have a conjunction of lines such as a RFQ seller, it means that no volume was transacted. On a computer screen, the shapes can be colored to represent the information or additional information. In these examples, the vertical bold lines are place on the X axis that represent the time of the auction. The horizontal bold line is places on the Y axis to represent the price at which the auction takes place. The volume of trade represented by each symbol can be expressed as either the width of the symbol or the height. Where there is an apex, that point represents both the time and price such as the Dutch, English, Negotiated and Single Price Auctions.

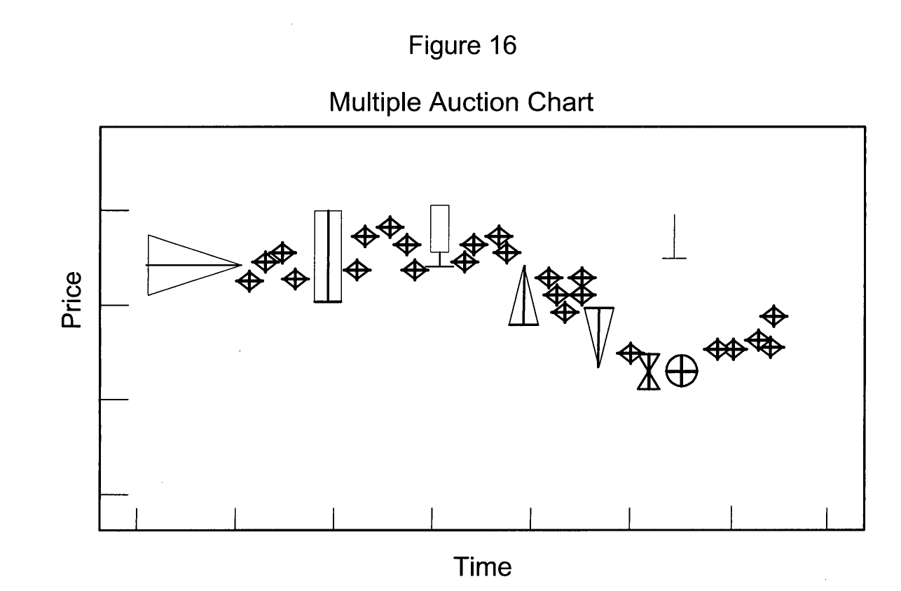

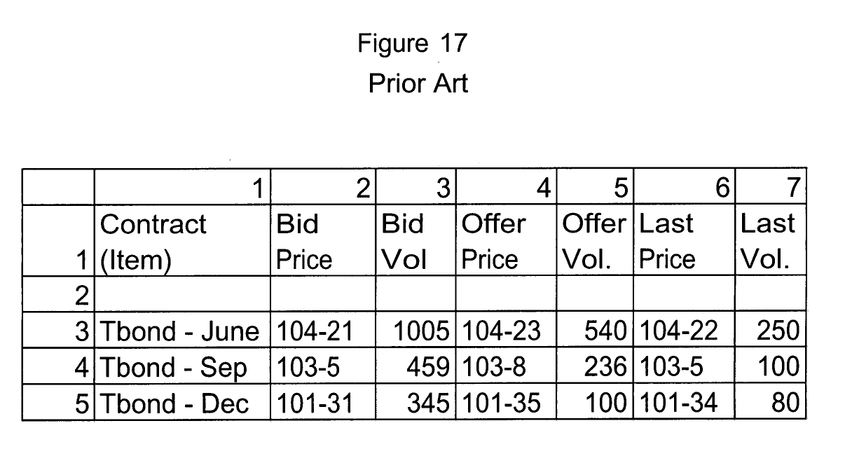

FIG. 16 portrays a method of displaying multiple auctions for any market, including but not limited to a futures, options or stock market. FIG. 16 illustrates one implementation of this method with all auctions on the same screen, unified by the price scale and/or unified by the time scale. The size of the icon in this implementation represents the size of the bid or offer. The chart set up screen (not shown) can be set for a group of items as set by the user, or a single item, such as 1 Gram Gold Bars. If set as a group, the user is able to set a spread price between the different items so all items in the group can be listed with a single price scale. If for example, a Gold Coin commanded a $2.00 premium per ounce over gold bullion, the user could enter the $2.00 differential so that auctions for both the bullion and the coin could be shown on the same chart, with the same price scale for easy comparison. Compare the chart in FIG. 15 to FIG. 11 which shows historic price activity in a typical single auction type of stock or futures chart. With just one auction type to display, the chart only needs show prices and time. The top of the bar is the high price for that segment and the bottom of the bar is the low price for that segment of time. Often a hash on the right side of the bar will indicate the last price traded during that time segment. In this implementation of this invention, the chart as shown in FIG. 16 can represent all types of auctions permitted at this exchange. The X axis, like typical charts represents time. The Y axis, like typical charts represents price. At any point of time, the trading activity of all auction types can be seen visually. The vertical position of each auction symbol represents the price activity in that auction. The horizontal position of the auction symbol represents the time of the auction. In this implementation, bold lines represent the “crosshairs” for locating the exact price and time. Also, on a computer screen, these symbols could take on color to represent more information. The user is able to filter this chart (chart filter screen not shown) by any number of filters to either increase the information resolution or, if there is too much information, reduce the amount of information. For example, the user could set a filter for:
Minimum transaction volume
User as individual, type, or group
Auction Type
Time of day
   FIG. 17 supplies a view of a method of displaying a typical futures CDA or Continuous Double Auction of 30 Year Treasury Bond Futures contracts by expiration months in column 1. It then shows the bid price and bid volume and offer price and volume. The final columns display the last price and the volume at that price.

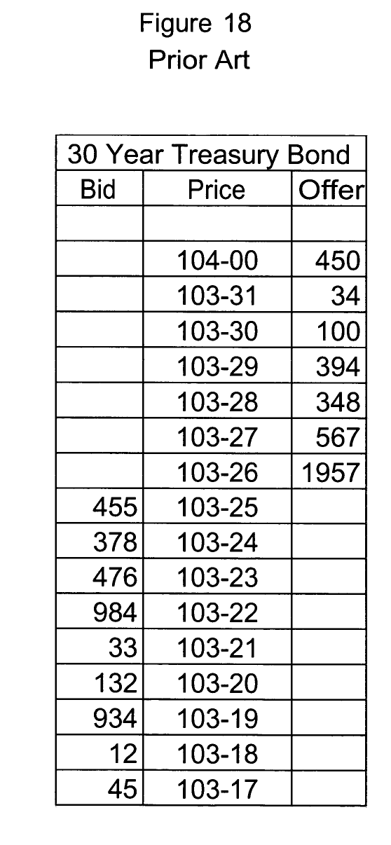

FIG. 18 shows an alternative arrangement of the display of prices by the most popular futures price and screen vendors who get prices from an exchange and display them in more usable fashion for the user. FIG. 18 displays a vertical price scale in the middle of the screen. The left column presents the volume of the bids each positioned at the price that those contracts (items) are bid for. The right column presents the volume of the offers, each positioned at the price that those items (futures contracts) are offered at. The user is also able to execute orders from these screens by clicking on an order. When a bid and an offer match in price they are executed to the extent of the volume available. These screens are a more sophisticated arrangement of the bids, offers and trades, but still represent one type of auction on the screen at a time, in this case, the CDA.

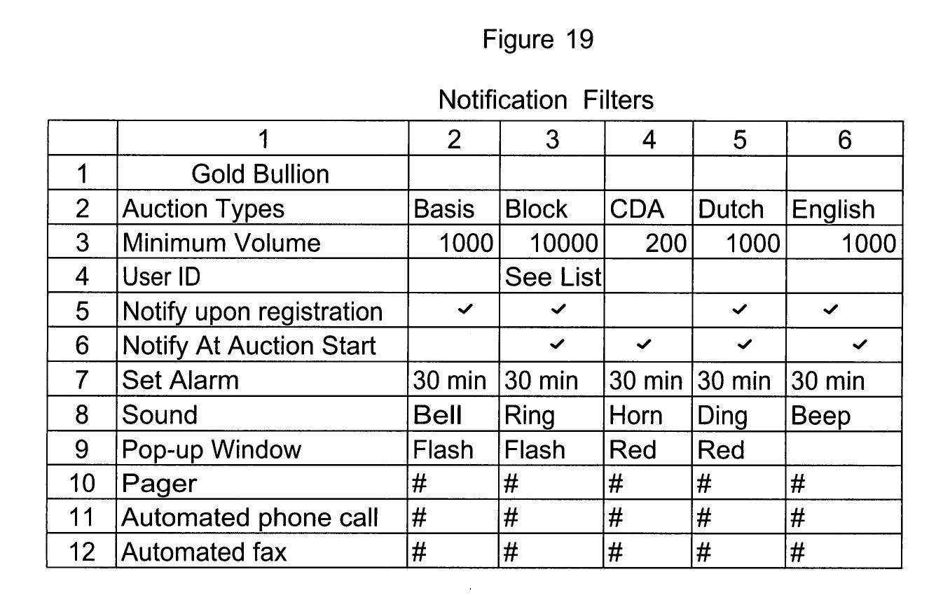

FIG. 19 reveals a notification selection screen. It allows a user to select what type of notifications they want to receive. Because an exchange with multiple integrated auctions has a lot of potential information for the user, the user may want to filter the information. The first row describes either a specific tradable item, or in this case, a group of items. The user is able to define a item group, in this case “Gold Bullion” (Group Definition screen not shown) which could include non-numismatic gold coins, one gram gold bars, one ounce gold bars, 10 ounce gold bars etc. The next row, in line 2, gives the list of auctions that are available for notification services. The user can then select which types of auction activity they wish to be notification. To reduce the number of notifications, the user in row 3 can set minimum volume numbers for each auction type. Under this selection, if a new auction is initiated with 50 units in the CDA auction, and the minimum is set by the user at 200 units as in this example in column 4, the user would not receive any advanced notification. Alarms can be set as sound or pop-up windows as in row 8 and 9, or can be turned on to generate other alerts via pager, phone and fax as in row 9-12.

VI. Existing Auction Types Integrated with Present Invention

The section which follows provides definitions, existing usage of auctions and examples of specific implementations of the present invention. This invention can also manage additional types of auctions created by users or by an auction host.

1. Block Trade

Definition: A Block Trade is a larger than normal volume trade that is usually pre-negotiated between high volume users. If either side were to place their high volume bid or offer in a CDA (Continuous Double Auction), it would be such a large order it would affect the market, and make it difficult to execute. Thus, a larger buyer for example would contact potential large sellers to find a price they could execute their purchase. Once agreed, the buyers and sellers go trade directly or go to a CDA market for execution, usually at a price higher than the current market if initiated by the buyer, or lower than the current market if initiated by the seller. Generally, since a block trade is negotiated outside of the published markets, it is generally given a low execution priority to prevent users from placing trades that do not have the advantages of exposure and price discovery.

Existing use: Firm A wants to purchase 100,000 share of IBM and is willing to pay $95.00. The current market on the NYSE is $94.00. Firm A calls firm B who states they are willing to sell 100,000 shares to Firm A at $95.00. The specialist at the NYSE is contacted and he “prints” the trade at the desired price. He also has other limit orders in the book and he elects to allows the sellers to sell at the higher price of the block transaction, giving them a better price than their limit sell order.

Present Invention: Firm A enters an Indication of Interest to buy IBM and it is responded to by Firm B via the message system or from a posted Indication of Interest that shows up on the price tables and price charts. Firm A and Firm B move to a Negotiated Auction and a price and volume are agreed to by both users. The price agreed is $2.00 higher than the current market. The completed order becomes a block trade and is submitted to the marketplace and the Priority Grid rules for execution. This particular example uses three auction types all processed on one exchange in one market place under one set of rules instead of private negotiations outside of the market place bringing a trade to an existing exchange.

2. Continuous Double Auction (CDA)

Definition: A continuous market is one where users at anytime during market hours can place a bid or offer as a limit order or market order or buy an offer or sell a bid. The users usually do not interact or negotiate directly with each other. A central exchange either manually or with a computer keeps track of all market actions. The exchange matches executable trades sending order status to the users. Exchanges may disseminate just the best bid or best offer, or a full range of bids and offers and their various prices. These orders are commonly sent electronically or through a broker.

Existing Use: NYSE or CBOT where users are limited to sending bids and offers with price limits or market orders. An order to buy 2000 shares of IBM at a price of 93.25 would be a typical order placed on the “book” making it available for immediate execution with a seller who matched that price. Execution is limited to an offer that adheres to the rules of the CDA market.

Present Invention: An order to buy 2000 shares of IBM and pay 93.25 would be the same as any other order in a CDA market and exchanges using the Auction Merger concept could use their present rules for the CDA. The difference with this invention is that the order to buy IBM could also be executed in a Dutch Auction happening simultaneously without any further action on the part of a user. As the offering price in a Dutch Auction fell in accordance to its rules, if the offer price matched a bid price in a CDA Auction, the Priority Grid could execute the orders from the different auctions.

3. Dutch Auction

Definition: The opening price is set for the item by the seller that is higher than the expected value of the item. With each time increment, the price is lowered one price increment. The first buyer to take the new offer is allowed to buy as much as the items as offered at that price. Remaining items remain in the auction and are sold successively lower prices in the same manner. This auction is typical of items that are perishable and need to be sold regardless of price. This is a transparent auction with all price information available to all users.

Existing Use: Once example is flower auctions where few sellers own perishable items with multiple smaller users interested in purchasing the flowers. Specifically if a seller has 1000 bundles of flowers to sell, the seller starts the auction at $2.00 per bundle. The buyers in the audience do not respond at that price. Every 1 minute, the offering price is lowered by 10 cents. When the price hits $1.50 a buyer bids for 500 bundles. The deal is consummated. At a price of $1.40, the seller sells 200 more and at $1.30 the seller sells the remaining 300 bundles.

Present Invention: A seller such as a large mutual fund may need to sell a large block of IBM shares by the close of trading to cover fund redemptions. The seller places a block of 1,000,000 shares of IBM in a Dutch Auction. Notifications are sent to all users who have set their notification filters for orders of this type. The Dutch Auction also appears in the quote page and the price chart. As the price of the shares drop in regular price increments with fixed time increments, these sell orders can be matched against CDA buy limit orders in the CDA “book”. If another large block trade were taking place at the same time, the Dutch Auction seller might also participate in the Block trade depending on the rules and priorities from the Priority Grid. The value in the present invention is the increased liquidity as bids from other auctions can be executed against the falling prices of the Dutch Auction and users from multiple auctions can participate because they all occur in the same market.

4. English Auction

Definition: This is an auction of a single item or fixed quantity of an item in which the sales price is determined by the highest bidder. The item is presented for auction, and the bidders place bids, with only the highest bid in action. Additional bids must be higher than the previous bid to be considered. At a fixed time, or after a maximum time after the last bid, the highest bidder is declared the winner and the trade is consummated. The English auction would be initiated by a seller of a item who believed that there was a demand that exceeded supply of the item, and where the amount of demand and the demand at various prices was unknown. The initiator would be willing to let the buyers to determine the final prices.

Existing use: An art auction is a typical example where there are many potential buyers of one item. An auction host will offer to sell a painting at $50,000. A bidder will bid $50,000. The auction host will ask if anyone is willing to pay $51,000 and another bidder will signal his willingness to pay $51,000. The bidding goes on until there are no additional bidders willing to pay more than the highest existing bid. The auction host will then declare the item sold to the highest bid to the bidder at that price.

Present Invention: As in all event auctions, the auction would be announced in the messaging system and the auction activity would appear on the main quote screen and in other active auctions. The minimum starting bid would be stated along with an end time to the auction (fixed or pause length between the improved bids.) If there were existing bids in the CDA that matched the sellers lot size and were the highest existing bid, that bid would be moved to the English Auction (if permissioned) and as allowed by the Priority Grid. As soon as the CDA bid was no longer the highest bid, it would move back to the CDA marketplace. If there were existing offers in a CDA market that were executable against a bid in the English Auction and met the minimum lot size it could be immediately executed as permitted by the Priority Grid, leaving the next highest bid the active bid in the English Auction. Or, in an alternative rule, orders in a CDA auction could be prohibited from executed against bids in an English Auction.

5. Indications of Interest

Definition: Indications of interest are inquiries to find interested users to be the counter-party to the user who initiates a trade. A user looking for indications of interest is not asking for firm bids or offers, but to find users to start an auction or negotiations and to find out how much size will be available that may not be published on existing markets. Indication of interest may not be an executable order, but are initiated to entice counter-party users to enter Negotiated or other Auctions.

Existing use: A user, who want to buy a large number of options will come to the floor of an options exchange and ask for indications of interest in selling 5000 MSFT (Microsoft) June 30 calls at $2.50. The market makers would indicate at current prices of the stock, they would be willing to sell 2000 options at $2.60. The buyer then knows there is not enough interest to fill the entire order.

Present Invention: As in other Event Auctions, the Indication of Interest will be posted on the main Quote Screen, the charts for that item and the messaging system will alert interested user into valuing, looking at their portfolios, checking potential hedges and so forth to see if they would be willing to trade and if so, at what price and what volume. Users in a CDA market would note the indication of interest and might adjust their orders accordingly. If an initiator of an indication of interest would receive no responses, the user would know that it was not much point in initiating an auction. If there were a significant response, the initiator of the indication of interest could initiate a specific auction type such as a Negotiated Auction or other Event Auction. All responses to the Indication of Interest would be automatically notified of the auction, either negotiated, RFQ, sealed bid etc. which would then integrate into the Auction Manager for execution according to the exchange rules in the Priority Grid.

6. Negotiated Auctions

Definition: Negotiated Auctions are usually bi-lateral in nature. Because of this, the many variables can be included in the negotiations such as price, delivery time, quality of items, delivery location, quantity, and packaging and credit terms. When all terms are agreed on a sale is consummated. Negotiated deals usually are peer-to-peer with both the buyer and seller a direct party to the contract.

Existing Use: A refiner of crude oil might negotiate the purchase of a particular quantity of crude oil (quality and type to be negotiated) to be delivered to a particular refinery in a series of delivery dates. The payment terms could be set to suit both users.

Present Invention: In this case, the buyer of the crude oil would state his ideal terms or range of acceptable terms in the Negotiated Auction set-up. (not shown). Like other Event Auctions, notifications would be disseminated. If the auction initiator choose, additional users could enter the negotiations with competing orders. With an open negotiation, the entire list of negotiated terms (price, volume, quality, delivery points, payment terms etc) could be published real time, and all users could improve any of the terms, not just price. The buyer could choose a seller, not just on price, but the reputation of the seller, better payment terms and so forth. Once the terms were agreed on, the sale information could be posted, including the users involved, or limited to price and volume. If the terms of a negotiated market would be so specific as to possibly exclude bids and offers in other auction types with standardized items, the purpose of publishing of the final deal would help maintain transparency and give other similar items the information to adjust pricing. With this full disclosure, the prices of related markets and the bids and offers would adjust accordingly by the users now informed of this information, even though the similar bids or offers could not necessarily be executed against the negotiated customized item.

7. RFQ (Request for Quote)

Definition: A user will contact a number of other known users interested in that particular item and request a quote for a certain order. The means of communication is usually electronic, phone or fax. The request can be one sided, such as a buyer requesting sellers only, or two sided, when the originating user doesn't want to reveal that he is a buyer in which case the initiator will ask for quotes for both to buy and sell a certain quantity of items. An RFQ usually contains the definition of the item to be traded and the volume of the item. It may contain other information such a quality, credit or delivery requirements. An RFQ is usually put out to multiple counter-parties with the best bid or offer selected. In verbal markets, the quote may only be an indication of interest and not be firm. (A firm quote is one that while exposed can be executed.)

Existing Use: OTC (Over-the-Counter) stock options with customized size, expiration date or exercise constraints with a limited universe of users to call. For example, Peter, an option trader will call John and ask, “Can I get a firm bid/ask quote for 5000 call options on IBM with a strike price of 102.25 expiring June 1 at 9:00 am EST, with American Exercise?”

Present Invention: An RFQ would be an electronic message sent to all interested parties for that item as in other Event Auctions. The RFQ would also be displayed on all similar items auction pages and main Quote Pages. The RFQ could either be one sided (RFQ to sell 100,000 IBM) or the RFQ could request both sides of the market (RFQ 100,000 IBM) It could include a time limit or other comments. The RFQ could define the response orders as actionable or as indications as defined by the exchange or the user. If actionable, these orders then could be permitted to participate in other concurrent auction activity and could be executed prior to execution by the originator of the RFQ. If the RFQ were a buyer looking for a seller, it could state a minimum price at which it were willing to buy. That bid could then be actionable in other auctions if permissioned. In any case, the RFQ activity would show up on the main Quote Page and in other auction pages for similar items.

8. Sealed Bid Auction

Definition: A Sealed Bid Auction is one where there is one buyer or seller and many counterparties. Like an RFQ, the initiator expects responses from many counter-parties, only the responses are kept secret until the end of the auction.

Existing use: A government contract to construct a building might be a sealed bid. Contractors will each enter the price they are willing to accept to build to specifications. The contractors do not know the other bids and are forced to price their bid without the benefit of knowing where their competitors are bidding. The auction has a time frame for responses. During the time frame, contractors are allowed to submit bids. Each contractor does not know who or the price of other bids since these are “sealed”. At the end of the time frame, the sealed bids are opened and the lowest bid is accepted from the approved bidders.

Present Invention: All active markets and interested users would be notified that a sealed bid auction is taking place. Preferably, the main quote screen would show if the auction was initiated by a seller or buyer and the size of the order, along with the time the auction ended. At the end of the auction all current bids or offers that could be executed in the CDA auction or other concurrent auctions even if they had not been able to be executed in the Sealed Bid auction if permitted by the Priority Grid. The exchange could give priority to orders existing prior to the initiation of the sealed bid auction, or placed during the sealed bid auction. At the end of the auction, in a preferred version, all CDA limit orders that had priority would be executed at the price of the sealed bid auction, not at their limit price, giving the CDA market the best execution or as otherwise determined by the execution priority in the Priority Grid.

9. Single Price Auction (SPA)

Definition: This is an auction where just like a continuous double auction, users send in bids and offers. Unlike the continuous market, the orders are not immediately executed, but held for a particular time, all to be executed at once if possible. This type of auction is used to execute orders that have accumulated during the time a market is closed to trading either as regular schedule or a news event or crises that causes volatility and the influx of orders at prices that are widely disparate. This auction allows for the orderly execution at fair prices of orders entered at multiple prices.

Existing Use: In the opening of a stock on the NYSE, the specialist will have received a number of orders to be executed on the opening of the market. These orders are placed in the “book.” These orders can be limit orders to buy (buy 5000 IBM pay 94.20), limit orders to sell, or market orders (buy at a price that will be executed on the open). The specialist will take all the bids, offers and market orders and select an opening price that executes as many of the orders as possible without trading higher than any remaining offers, or lower than any remaining bids. Also, there must be no remaining executable orders left after the opening execution. All bids and offers and market orders are traded at the one opening price regardless of the limit price entered.

Present Invention: The algorithm that determines the opening price can display where the market will open and disseminate this information on a real time basis, or the exchange can limit this information. Under the preferred usage, the exchange will disseminate the calculated opening price on a continuous basis. The owners of the limit orders in the book of a CDA auction can anticipate where the market will open and adjust their bids and offers accordingly. As they adjust their limit orders, this will in turn, change the expected opening price. This auction is most likely to be employed on the opening of the market after a period of closure. It could also be used at anytime during a period of volatility, order imbalance, or lack of liquidity. The exchange could announce a time for a Single Price Auction when market events made this the best type of auction to use. The exchange could declare a time for a single price auction on a regular basis (i.e. every hour, once a day etc.), or a user could request a single price opening auction. If the customer initiates a SPA, it is unlikely that the CDA or other concurrent auctions would be stopped since that would give all market users the ability to close a market for a limited period of time. However, if a customer initiated the SPA, subsequent orders would have to be designated as permissioned to be allowed to participate in the SPA. If the order were designated for the CDA, it would be available for immediate execution against an existing counter-offer. If it were placed in the SPA, it would only be available for execution at the time of the auction end. The auction host has the choice of stopping the market for a period prior to the SPA, creating SPA auctions to serve as mini openings as often as the market needed. It has the choice of leaving all markets open during the SPA If, for example the CDA is left open during a SPA, the orders in the SPA would not interact with the orders in the CDA. The limit or market orders in the SPA would be held until SPA execution time and executed or not executed as applicable. The initiator of the SPA order could have a choice as to cancel the order if not executed in the SPA or roll the order into the CDA. The auction host has the option of creating the rules for their markets in the Priority Grid.

10. Spread Trading:

Definition: Spread trading (also referred to in some markets as basis trading) is buying and selling similar items with a price differential between the items to reflect the differences in desirability or to create a position that reflects an opinion on the future spread price between two or more items.

Existing Use: When a user might buy 10 year notes and sell 5 year notes to reflect a belief in the future of interest rates for debt of different duration.

Present Invention: A user could place an order with spread pricing for similar items that could compete in other auctions, and automatically adjust their pricing based on the designated primary market to reflect the net price in ancillary markets. For example, if there a market for US Treasury bonds, 10 year notes, 2 year notes and 1 year notes, the order could be priced based on the 10 year notes, with a spread differential for the other sections of the yield curve (maturity differences). In addition to a price spread, a volume spread could be included so that for example, two one year notes would equal one 10 year note. This would allow the user to place one order in the 10 year notes and have other orders generated in similar auctions re-price themselves as the pricing was changed in the 10 years. The spread trade could be priced from the bid, offer or last trade of one item which would automatically generate a bid or offer in another item, in any other permissible auction type. With a new range of items that can be traded with this invention, the user will face the challenge of maintaining a presence in a number of new markets each with a variety of auctions. The ability to automate spread pricing in a range of items will enhance the liquidity and fair pricing of a wider range of items.

VII. Additional Features of the Invention

User control of “frozen” orders: The user can control which auctions an order will participate in on an order by order basis or in groups or by types of orders or items or by default. An order entered into the CDA as a limit order could specify permissions to trade in other auction types. Because other auction types may freeze the bid or offer for a period of time, some CDA order users may prefer not to participate in other auctions since flexibility is more important than possible price improvement. Each user could specify defaults for all orders, or specific individual order permissions for participating in other auctions. For example, a CDA order may wish to participate in a Dutch auction since the execution is immediate, but not wish to participate in an English Auction which would hold the bid or offer during the period of time it was the best price. Alternatively, the order could be permissioned for auctions that may freeze an order for some period of time, but the user can set a maximum “freeze time” for each order. This is particularly helpful when orders are frozen because of a large number of spread orders that freeze other users orders while they determine the availability of other dependent orders for execution. If an order from one auction is frozen by another auction, this condition may be indicated with symbols, fonts, colors or typically being “grayed out.”

Messaging System: All scheduled auctions may be published for interested users. All special auctions may send notification to interested users of the special auctions along with the rules for that auction. Because differing auction types can only be successful if other interested users attend those auctions, a messaging system, in a preferred embodiment, notices of all active auctions can be integrated into the main quote page for each item, and in auctions for similar items. In addition, interested users can sign up for notification of auction schedules and notification of unscheduled auctions either through public medium such as internet email or internal messaging systems, or automated phone calls, faxes or pager alerts. Users may elect which auction notifications they wish to receive. The invention may utilize a filter which may include, but which is not limited to: auction type, item type, order size, or order originator.

Auction Participant Reputation System: When a firm bid or offer is posted on futures or stock exchange, the reputation of the initiator is not important. The price is backed up by the exchange rules and clearing firm payments, so it really does not matter who the counter-party is as far as trade execution. However, if the initiator can not only initiate a bid or offer, but can initiate the type of auction, the initiator has the power to illicit a response from the market place. That response in and of itself could provide valuable information to the initiator of the auction without completion of the trade. At the same time, many users may wish to remain anonymous because their buying and selling would give away their positions or strategies and make it harder to execute. The problem is that if every user is anonymous, then the exchange can be the victim of the equivalent of auction graffiti artists. By initiating RFQ auctions for the sole purpose of gathering information on pricing without completing the trade, these false auctions would discourage responders from giving out such price information if a large number of the auctions resulted in no trading activity. The users can be labeled with a reputational system and still remain anonymous. The reputational system can be a statistical record of auction activity of a user and/or a record of satisfaction by other involved users. For example, the statistical reputation can be a number assigned depending on the ratio of volume of auctions initiated to actual trades completed. If, for example, a firm initiated 100 RFQ auctions with a total share or item volume of 10 million and did not execute on any of them, they would have a score of 0. If on the other hand they executed 5 million, they might have a score of 50. Alternatively, or in conjunction with a statistical reputational system, after each auction, the respondents to an auction who put up firm quotes could also vote on their satisfaction with the auction initiator, giving them a score. Any auction initiator would then have that score or scores displayed on the auction board allowing respondents to use that information to shape the type of response they wanted to make. All auction activity could be used to best create a picture of behavior to help users determine how they would like to respond to other users based on the reputational statistics or satisfaction by other users. A graphical view (not shown) of each user can be created to give all users a quick summary of the other user's behavior.

VIII. Advantages of the Present Invention

To the user: The user gets more control of their own order which is a real advantage because the user is best informed as to how best to handle his own order. The user can control the type of auction, the auctions the order participates in and can have the order executed at better prices from different auction types.

For example, the CDA market is has problems because a large offer in a CDA market reduces the price at which it can be sold because everyone is privy to the order, and if no buyer order is immediately attracted to the order, the rest of the world can use this order as a safety net while they sell at lower prices. The present invention allows a large seller in this case to create an auction which is communicated through the notification messaging system to attract larger buyers in an orderly manner. The orders that are in the CDA market will participate in any other type of auction that they are permissioned to participate in, increasing the liquidity.

To the exchanges: The Auction Merger gives exchanges the ability to list a wide range of items without having to try to pre-determine the best form of auction for each item. It expands the potential items to be traded because many items will thrive in a system of multiple auctions that my die in the constraints of only a CDA.

To the internet auction sites: The Auction Merger gives auction sites the ability to improve completion of trades by aggregating interest in fungible or semi-fungible products by putting multiple auctions into one market for execution.

To the economy and broader market place: More and more items can be listed on centralized exchanges with centralized clearing, reducing counter-party risk, legal fees, miss-priced trades and improving price discovery and hedging opportunities. Also, moving more items to centralized exchanges opens the doors to more users. More users trading more items means that risks of all types can be transferred from users who are not as capable of handling particular risks to users who are willing to handle particular risk.

For best price execution: The merger of multiple auctions with coordinated pricing execution gives the best of all worlds to each order. It protects each order from trade-through, missed executions, and gives each order the ability to be executed at the best available price. As the trading environment changes, the auction types initiated by users will change to adapt to current market conditions without the exchange management being forced to evaluate or create new rules. A changing trading environment could include irregular volume, large orders, number of users, the types of users and buyer/seller imbalances. The orders can automatically flow to the best auction type, as judged by the user who places the order. It is expected that certain auction types will predominate at each stage of a items growth or cycle, while still allowing for all other auction types to co-exist, benefiting all orders.

IX. Glossary & Abbreviations

Actionable Order

An order that is available for immediate execution if an opposing order meets the required criteria

Active Price

This is a price scale that represents prices in which there are active orders, or orders within the range of interest of the auction users Ask

An offer, or price to sell a item

Auction

Any transaction involving an item, a user who receives or view data concerning a transaction, a potential seller and/or a potential buyer. An auction may include no bids or offers, one bid or offer or a numbers of bids or offers,

Auction Host

An auction host is a person, company or entity that enables an on-line auction. In general, an auction host controls the computer or server and software that present the auction market to users.

Auction Type

A defined process with specific rules where buyers and sellers meet to transact purchases or sales. Examples: English auction, Continuous Double Auction, Dutch Auction, Classified advertising in newspaper

Best Price

This is the highest price if the order is a bid or purchase, and the lowest price if the order is an offer or sale.

Bid

A price to purchase a defined item

Block Trade

A block trade is a larger than normal volume trade that is usually pre-negotiated between high volume users.

Book

A list of actionable bids and offers managed by the auction host or exchange

Clearing

After a trade is consummated, it is “cleared” by delivery of the item and payment often by a third party “Clearing House”

Continuous Double Auction (CDA)

A continuous market is one where users at anytime during market hours can place a bid or offer as a limit order or buy an offer or sell a bid. A central exchange either manually or with a computer keeps track of all market actions. The exchange matches executable trades sending order status to the users. Exchanges can disseminate just the best bid or best offer, or a full range of bids and offers and their various prices. These orders are commonly sent electronically or through a broker. Examples: New York Stock Exchange

Counter-Party

The user who has a buy order that responds to a sell order, or a sell order that responds to a buy order.

Dutch Auction

This auction is typical of items that are perishable and need to be sold regardless of price. This is a transparent auction with all price information available to all users. The opening price is set for the item that is higher than the expected value of the items. With each time increment, the price is lowered one increment. The first person to take the new offer is allowed to buy as much as the items as offered at that price. Remaining items remain in the auction and are sold successively lower prices in the same manner. This auction tends to be used when perishable items need to be sold immediately. Examples: Flower auctions in Holland

English Auction

This is an auction of a single item or fixed quantity of an item in which the sales price is determined by the highest bidder. The item is presented for auction, and the bidders place bids, with only the highest bid in action. Additional bids must be higher than the previous bid. At a fixed time, or after a maximum time after the last bid, the highest bidder is declared the winner and the trade is consummated. Examples: Southeby's auctioning a painting

Event Auction

An auction with a specific time frame such as an English or Dutch Auction versus a continuous auction such as the CDA.

Exchange

An exchange is a single entity or governing body that has a set of rules that govern access and membership, the type of items to be traded, the trading rules and types of auctions permitted. It may be government sanctioned or regulated and acts as the auction host. Examples: They New York Stock Exchange, The Chicago Board of Trade

Execution or Executed Order

The completion of the purchase and sale that obligates the buyer to pay for the item and the seller to deliver the item according to the rules of the exchange.

Firm Quote

A quote that is available for immediate execution.

Frozen Order

An order that is not actionable for a period of time in one auctions while it is considered for execution in another auction.

Fungible

A item that is interchangeable, equal in exchange and substitutable. For example, an ounce of 0.999 fine gold is fungible with a similar ounce of gold.

Indications of Interest

Indications of interest or inquiries to find interested users interested in being the counter party to the trade initiator. A user looking for indications of interest is not asking for firm bids or offers, but to find users to start an auction or negotiations and to find out how much size will be available that may not be published on existing markets.

Initiator

The person who initiates an order (initiating order) or auction type (initiating auction). A person who accepts an initiated order is a responder or (responding order)

Initiated Order

An original order that is placed in an auction or creates an auction that is actionable.

Item

Any good, service or intangible which may be conveyed in an auction.

Liquidity

The ability to quickly buy or sell an item in large quantity without a price discount because of a large numbers of active buyers and sellers competing for each order.

Market

A nexus of auctions, data, items and users, including potential sellers and buyers.

Market Maker

A person who is designated to make continuous bids and offers on an exchange and is often a member of that exchange.

Market Place

An open market may include different exchanges, various entities, items, multiple sets of rules and loosely defined boundaries or a reference to a group of exchanges. Examples: A flea market, Classified Advertising

Negotiated Trades

Negotiated trades are usually bi-lateral in nature. Because of this, the many variables can be included in the negotiations such as price, delivery time, quality of items, delivery location, quantity, and packaging and credit terms. When all terms are agreed on a sale is consummated. Negotiated deals usually are peer-to-peer with both the buyer and seller a direct party to the contract.

Network

One or more connections for enabling communications between or among users.

Offer

A price to sell a defined item. (note: the exception in the real estate market where an offer is a bid price to purchase a house)

Opposing Order

A sell order if the existing order is a buy order or a buy order if the existing order is a sell order.

Order

A declaration of a bid or offer that is authorized to purchase or sell a defined item under the rules of the auction and is actionable.

Over-the-Counter

Items that trade directly between two users without the benefit of an exchange or impartial clearing firm. Each user assumes credit and delivery risk.

Permissioned Order

In this invention, orders can be permissioned to participate in a number of auction types on an auction by auction spread. Orders that are not permissioned for a particular auction type, may not be executed in that auction, even if all other criteria qualify the order to do so.

Price Improvement

When a new bid is entered that is higher than an existing bid, or a new offer is entered that is lower than an existing offer.

Price Improved

When an offer to sell is executed at a higher price or a bid to buy is executed at a lower price than the original limit order.

PX

Abbreviation for Price

Quote Screen

This is the main screen that gives an overview of the market, historical price activity, current auctions and message board.

Regulated Market

A market place for certain items such as stocks that is regulated by a government agency such as the Commodity Futures and Trading Commission or the Securities and Exchange Commission and limits all activity to approved exchanges

Regulated Exchange

An exchange that is approved for trading by a government agency in a regulated market place. Access to the exchange is limited to its members, member firms, licensed brokerage firms and their qualified customers.

Request for Quote (RFQ)

A market user will contact a number of other known market users and request a quote for a certain order. The means of communication is usually electronic, phone or fax. The request can be one sided, such as a request for sellers only, or two sided, requesting quotes for both to buy and sell a certain quantity of items. An RFQ usually contains the definition of the items to be traded and the volume of items. It may contain other information such a quality, credit or delivery requirements. An RFQ is usually put out to multiple counter-parties with the best bid or offer selected.

Responder

A person who accepts an initiated order or auction and is a responder with a responding order.

Responding Order

An order that counters an initiated order.

Sealed Bid Auction

A Sealed Bid Auction is one where there is one buyer or seller and many counterparties. Like an RFQ, the initiator expects responses from many counter-parties, only the responses are kept secret until the end of the auction.

Single Price Auction (SPA)

This is an auction where just like a continuous auction, users send in bids and offers. Unlike the continuous market, the orders are not immediately executed, but held for a particular time, with all eligible orders to be executed at the same time at a single price determined by an algorithm.

Spread Trading

Spread trading is buying and selling similar items with a price differential between the items to reflect the differences in desirability.

Trade-Through

This is an executed trade that is executed at a price higher than another existing offer or lower than another existing bid. The existing bids and offers miss trading at a price better than their limits and either the bid or offer in the executed trade misses execution at a better price.

Transparent

An auction that displays all information about the item and the orders such as a Dutch Auction

User

A person, company, firm, entity or agent that participates in a market as a viewer of data, an auction user or auction creator.

Volatility

A measure of the change of price of an item over a given period of time

X. Hardware & Software Implementations

The present invention may be implemented using a personal computer, browser software and an Internet connection. In alternative embodiments of the invention, a private or closed network may be employed to connect selected users.

Other hardware implementations may incorporate a tablet or laptop computer, a personal digital assistant, a cell phone, a television monitor or any other device or appliance that allows users to view data and/or participate in the auction market.

The invention may utilize software which is generally known in the art. As an example, software that is similar to that used by eBay® may be modified to practice the present invention.

In general, the software which creates the auction market runs on one or more servers. Users connect to the servers over a network like the Internet.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the claims that follow. The various alternatives for providing an Auction Merger System that have been disclosed above are intended to educate the reader about preferred embodiments of the invention, and are not intended to constrain the limits of the invention or the scope of claims.

1. A method comprising the steps of:
providing a market means for a plurality of auctions;
said plurality of auctions including a plurality of generally simultaneous auctions;
said plurality of generally simultaneous auctions including auctions of different type; and
integrating said plurality of auctions in said market means.

2. A method as recited in claim 1, further comprising the step of:
displaying said market means using a computer and a graphical user interface.

3. A method as recited in claim 1, in which said market means also enables a plurality of users to view a plurality of data concerning said market means.

4. A method as recited in claim 3, in which said market means also enables at least two of said plurality of users to conduct a transaction.

5. A method as recited in claim 3, in which said market means also enables a user to place an order

6. A method as recited in claim 3, in which said market means also enables a user to place an order in a Continuous Double Auction

7. A method as recited in claim 3, in which said market means also enables said plurality of users to participate in said plurality of generally simultaneous auctions.

8. A method as recited in claim 3, in which said market means also enables a user to create a rule for an auction.

9. A method as recited in claim 3, in which said market means also enables a user to reduce the risk related to an auction.

10. A method as recited in claim 3, comprising the additional step of:
connecting said plurality of users to said market means using a network.

11. A method as recited in claim 10, in which said network is the Internet.

12. A method as recited in claim 10, in which said network is a private network.

13. A method as recited in claim 1, in which said plurality of auctions are conducted generally in real time.

14. A method as recited in claim 1, in which said market means is defined by said plurality of users.

15. A method as recited in claim 1, in which one of said types of auctions is an English auction.

16. A method as recited in claim 1, in which one of said types of auctions is a Dutch auction.

17. A method as recited in claim 3, further comprising the steps of:
providing an auction manager means for providing a message to one of said users.

18. A method as recited in claim 17, in which said message is an alert concerning a potential transaction.

19. A method as recited in claim 1, further comprising the step of:
allowing a user of said market means to determine the best type of auction for an order

20. A method as recited in claim 1, further comprising the step of:
allowing a user of said market means to create a type of auction best suited for an order

21. A method as recited in claim 1, further comprising the step of:
creating a ranking system for an auction initiator so a user of said market means can make a judgment on the intent of an auction initiator.

22. A method as recited in claim 1, further comprising the step of:
providing a user of said market means with the ability to choose which type of auction in which an order is permissioned to participate.

23. A method as recited in claim 1, further comprising the step of:
providing a user of said market means with the ability to add a field as said user enters data to expose only those fields that need information from said user on a real time spread

24. A method as recited in claim 1, further comprising the step of:
showing multiple auction volume data for a plurality of auctions in said market means that are all linked to the same exchange.

25. A method as recited in claim 2, further comprising the step of:
a method of using a different symbol for a different auction type in said graphical user interface.

26. A method as recited in claim 25, in which said different symbol is displayed on a single screen.

27. A method as recited in claim 25, in which said different symbol is displayed so that a price is displayed along an axis.

28. A method as recited in claim 25, in which said different symbol is displayed so that time is displayed along an axis.

29. A method as recited in claim 25, in which the size of a symbol is matched to the volume of an order in said market means.

30. A method as recited in claim 1, further comprising the step of:
allowing a user of said market means to enable an auction notification based on an auction initiator.
